(19) United States
(12) Patent Application Publication
(10) Pub. No.: US 2025/0383231 A1
(43) Pub. Date: Dec. 18, 2025

(54) OPTICAL CALIBRATION STRUCTURES FOR OPTICAL PROBES, OPTICAL PROBE SYSTEMS THAT INCLUDE THE OPTICAL CALIBRATION STRUCTURES, AND METHODS OF CALIBRATING A PLURALITY OF OPTICAL PROBES

(71) Applicant: FormFactor, Inc., Livermore, CA (US)

(72) Inventors: Quan Yuan, Dublin, CA (US); Eric Robert Christenson, Tualatin, OR (US); Daniel Rishavy, Austin, TX (US); Michael E. Simmons, Colton, OR (US); Joseph George Frankel, Beaverton, OR (US)

(21) Appl. No.: 19/226,846

(22) Filed: Jun. 3, 2025

Related U.S. Application Data
(60) Provisional application No. 63/661,159, filed on Jun. 18, 2024.

(51) Int. Cl. G01J 1/02; G01J 1/04; G01J 1/42

(52) U.S. Cl. CPC G01J 1/0295; G01J 1/0414; G01J 1/42

(57) ABSTRACT

Optical calibration structures for optical probes, optical probe systems that include the optical calibration structures, and methods of calibrating a plurality of optical probes. The optical calibration structures include a reflector, an obstructive structure, and an optical detector. The optical probe systems include the optical calibration structure, a chuck, an optical assembly, and a signal generation and analysis assembly. The methods include methods of operating the optical probe systems and/or methods of utilizing the optical calibration structures.

### RELATED APPLICATION

This application claims priority to U.S. Provisional Patent Application No. 63/661,159, which was filed on Jun. 18, 2024, and the complete disclosure of which is hereby incorporated by reference.

### FIELD OF THE DISCLOSURE

The present disclosure relates generally to optical calibration structures, to optical probe systems that include the optical calibration structures, and to methods of calibrating a plurality of optical probes.

### BACKGROUND OF THE DISCLOSURE

Optical probe systems may be utilized to probe, to optically probe, to test, and/or to optically test the functionality, operation, and/or performance of an optical device. This may include directing one or more optical test beams incident upon the optical device and/or receiving one or more optical resultant beams from the optical device.

In general, it may be desirable to calibrate an optical probe system prior to, during, and/or after testing of an optical device with the optical probe system. However, conventional calibration structures and/or methodologies may be ineffective for certain types of calibrations. Thus, there exists a need for improved optical calibration structures, optical probe systems that include the optical calibration structures, and/or methods of calibrating a plurality of optical probes.

### SUMMARY OF THE DISCLOSURE

Optical calibration structures for optical probes, optical probe systems that include the optical calibration structures, and methods of calibrating a plurality of optical probes. The optical calibration structures include a reflector and an optical detector. The reflector may be configured to receive an optical test beam of electromagnetic radiation from the optical probe and to reflect the optical test beam as a reflected beam and at a reflection angle with respect to the optical test beam. The optical detector may be configured to receive the reflected beam and to produce a detector electrical output that quantifies at least one property of the reflected beam. The electromagnetic radiation may define a beam path between the optical probe and the optical detector. The optical calibration structure also may include an obstructive structure positioned along the beam path. The obstructive structure may include an unobstructed region configured to permit electromagnetic radiation that is incident thereon to be received by the optical detector and an opaque region configured to restrict electromagnetic radiation that is incident thereon from being received by the optical detector.

The optical probe systems include the optical calibration structure, a chuck, an optical assembly, and a signal generation and analysis assembly. The chuck may define a support surface configured to support a substrate that includes a plurality of optical devices. The optical probe assembly may include the optical probe. The signal generation and analysis assembly may be configured to at least one of provide the optical test beam to the optical probe and receive an optical resultant beam from the optical probe. The optical calibration structure may be positioned to receive the optical test beam from the optical probe.

The methods include simultaneously providing a corresponding optical test beam of electromagnetic radiation to each optical probe of the plurality of optical probes and simultaneously emitting the corresponding optical test beam from each optical probe. The simultaneously emitting may be responsive to the simultaneously providing. The methods also include directing the corresponding optical test beam of a selected optical probe of the plurality of optical probes along a corresponding beam path that extends through the obstructive structure, is reflected by the reflector, and is incident upon the optical detector. The methods further include restricting at least one other corresponding optical test beam of at least one other optical probe of the plurality of optical probes from being incident upon the optical detector. The restricting may be concurrent with the directing and may be performed utilizing the obstructive structure. The methods also include quantifying at least one property of the corresponding optical test beam of the selected optical probe utilizing the optical detector.

### BRIEF DESCRIPTION OF THE DRAWINGS

FIG. 1 is a schematic illustration of examples of optical probe systems that include optical calibration structures, according to the present disclosure.

FIG. 2 is a schematic side view illustrating examples of a region of the optical probe system of FIG. 1.

FIG. 3 is a less schematic side view illustrating examples of a region of the optical probe system of FIG. 1.

FIG. 4 is a less schematic side view illustrating examples of a region of the optical probe system of FIG. 1.

FIG. 5 is a schematic top view illustrating examples of a region of the optical probe system of FIG. 1.

FIG. 6 is a schematic top view illustrating examples of a region of the optical probe system of FIG. 1.

FIG. 7 is a schematic illustration of an example of an obstructive structure that may be included in optical calibration structures according to the present disclosure.

FIG. 8 is a schematic illustration of an example of an obstructive structure that may be included in optical calibration structures according to the present disclosure.

FIG. 9 is a schematic illustration of an example of an obstructive structure that may be included in optical calibration structures according to the present disclosure.

FIG. 10 is a schematic illustration of an example of an obstructive structure that may be included in optical calibration structures according to the present disclosure.

FIG. 11 is a schematic illustration of examples of obstructive structures that may be included in optical calibration structures according to the present disclosure.

FIG. 12 is a less schematic profile view illustrating an example of an optical calibration structure according to the present disclosure.

FIG. 13 is a schematic side view illustrating examples of optical calibration structures according to the present disclosure.

FIG. 14 is another schematic side view of the optical calibration structures of FIG. 13.

FIG. 15 is a schematic top view of the optical calibration structures of FIGS. 13-14.

FIG. 16 is profile view illustrating an example of a reflector that may be included in optical calibration structures, according to the present disclosure.

FIG. 17 is a flowchart depicting examples of methods of calibrating a plurality of optical probes of an optical probe assembly of an optical probe system, according to the present disclosure.

### DETAILED DESCRIPTION AND BEST MODE OF THE DISCLOSURE

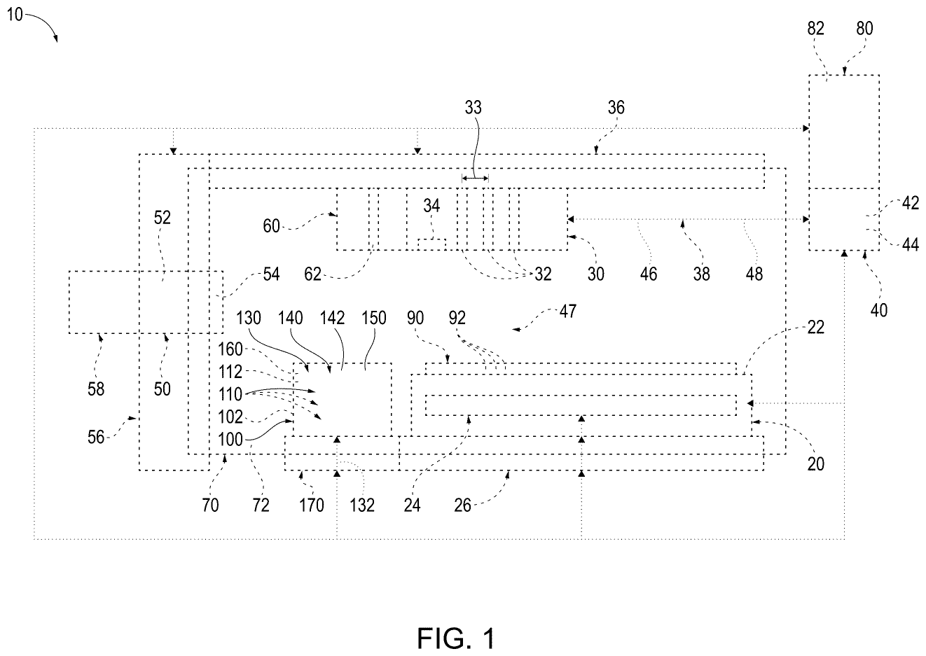

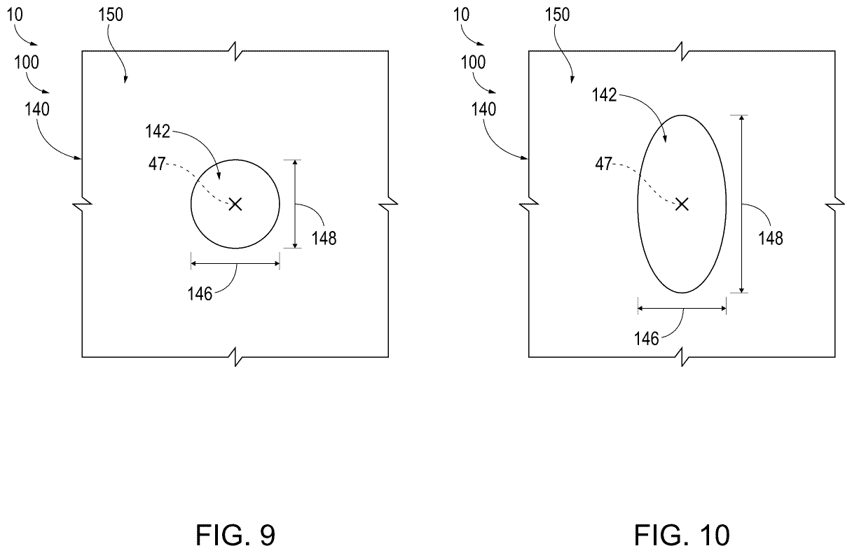

FIGS. 1-17 provide examples of optical probe systems 10, of optical calibration structures 100, of components thereof, and/or of methods 200, according to the present disclosure. Elements that serve a similar, or at least substantially similar, purpose are labeled with like numbers in each of FIGS. 1-17, and these elements may not be discussed in detail herein with reference to each of FIGS. 1-17. Similarly, all elements may not be labeled in each of FIGS. 1-17, but reference numerals associated therewith may be utilized herein for consistency. Elements, components, and/or features that are discussed herein with reference to one or more of FIGS. 1-17 may be included in and/or utilized with any of FIGS. 1-17 without departing from the scope of the present disclosure.

In general, elements that are likely to be included in a particular embodiment are illustrated in solid lines, while elements that may be optional are illustrated in dashed lines. However, elements that are shown in solid lines may not be essential to all embodiments and, in some embodiments, may be omitted without departing from the scope of the present disclosure.

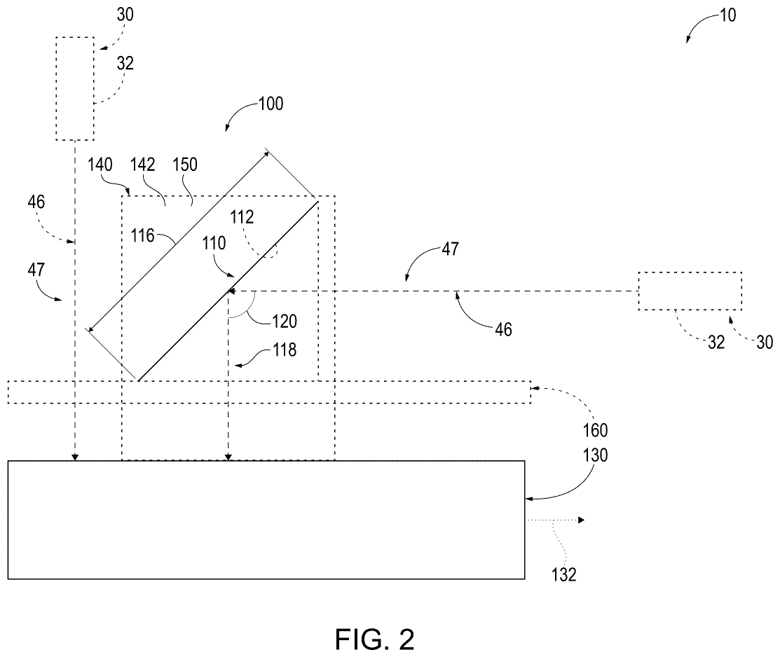

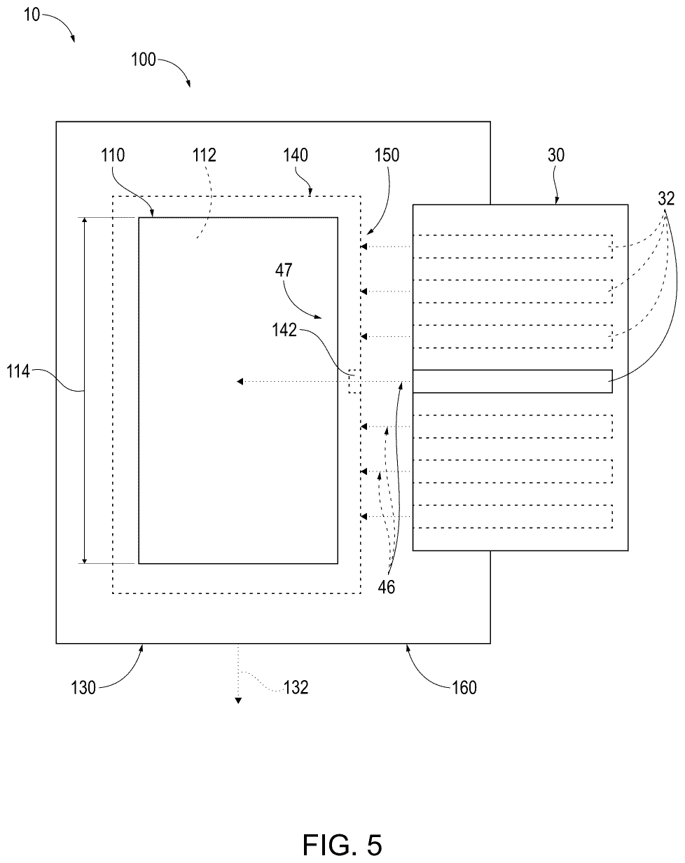

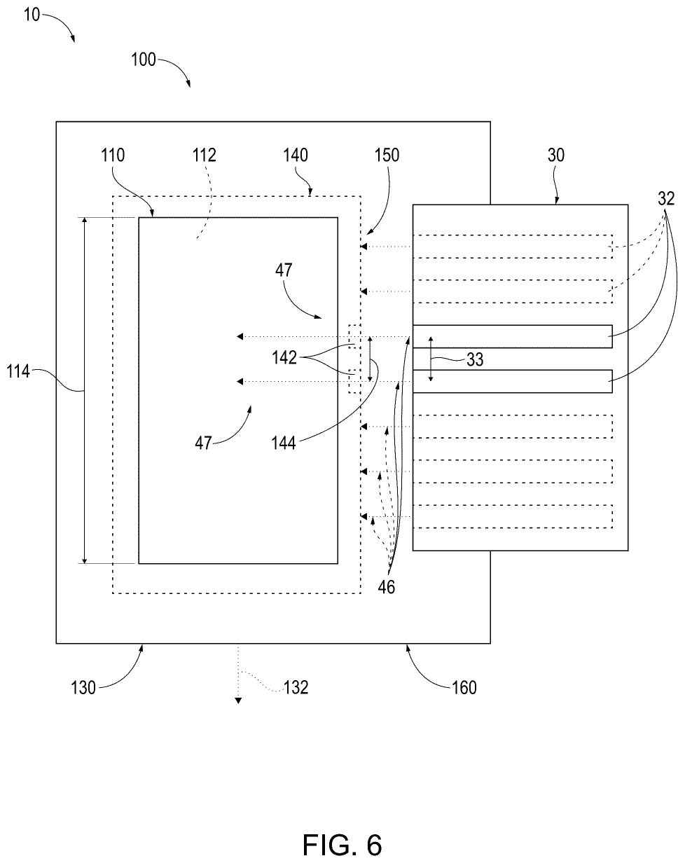

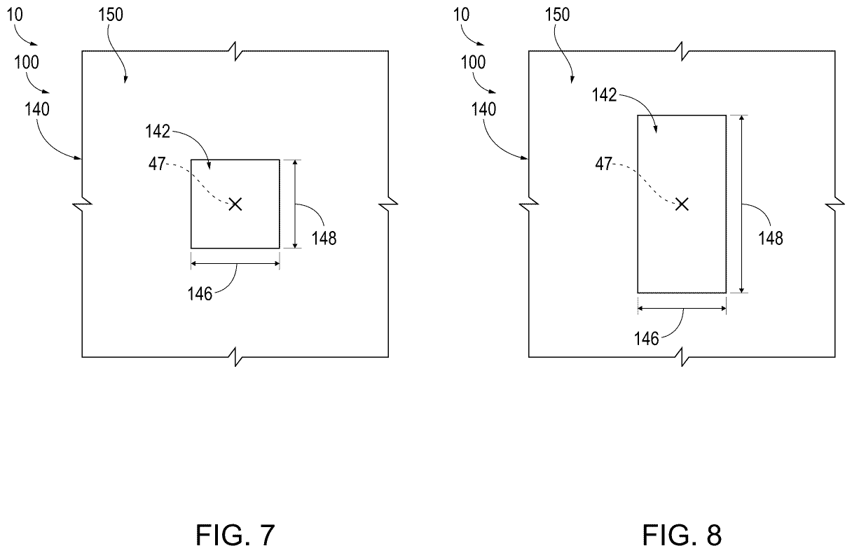

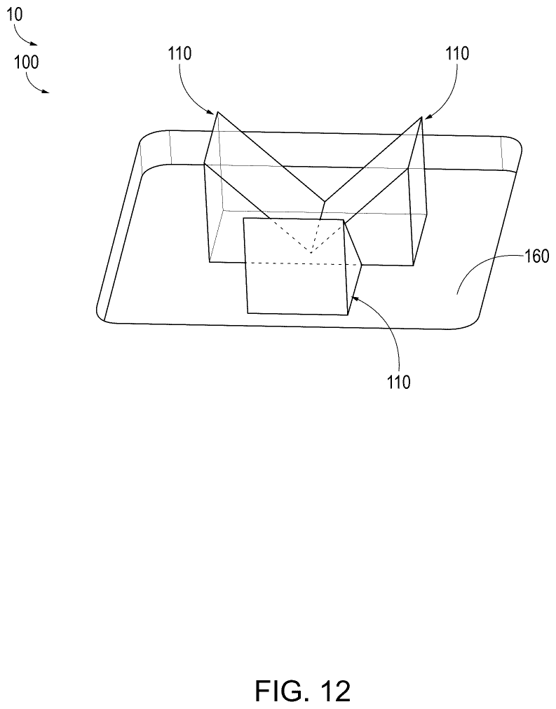

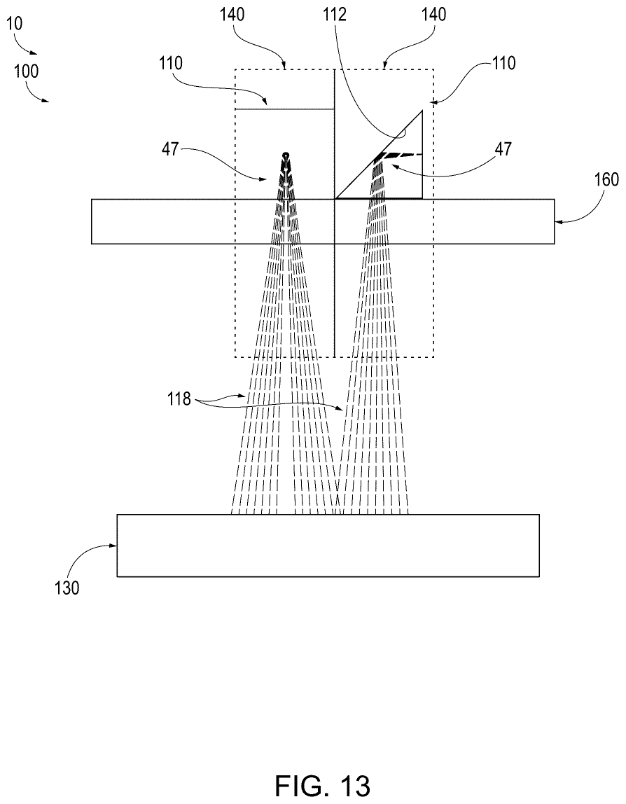

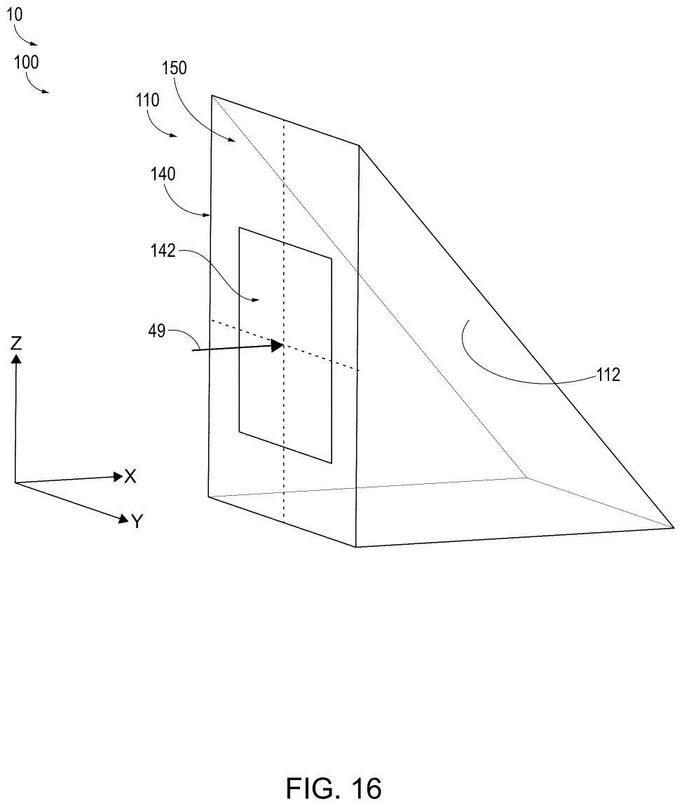

FIG. 1 is a schematic illustration of examples of optical probe systems 10 that include optical calibration structures 100, according to the present disclosure, FIGS. 2-4 are schematic side views illustrating examples of regions of the optical probe system of FIG. 1, and FIGS. 5-6 are schematic top views illustrating examples of regions of the optical probe system of FIG. 1. FIGS. 7-11 are schematic illustrations of examples of obstructive structures 140 that may be included in optical calibration structures 100 according to the present disclosure. FIG. 12 is a less schematic profile view illustrating an example of an optical calibration structure 100 according to the present disclosure, and FIGS. 13-15 illustrate various views of examples of optical calibration structures 100 according to the present disclosure. FIG. 16 is a profile view illustrating an example of a reflector 110 that may be included in optical calibration structures 100, according to the present disclosure.

As collectively illustrated by FIGS. 1-16, and with specific reference to FIG. 1, optical probe systems 10, which also may be referred to herein as probe systems 10, include a chuck 20 that defines a support surface 22. The support surface is configured to support a substrate 90 that includes a plurality of optical devices 92. Probe systems 10 also include an optical probe assembly 30 that includes an optical probe 32. Probe systems 10 further include a signal generation and analysis assembly 40, which is configured to provide an optical test beam 46 of electromagnetic radiation to the optical probe and/or to receive an optical resultant beam 48 of electromagnetic radiation from the optical probe. Probe systems 10 also include an optical calibration structure 100, which may be positioned to receive the optical test beam from the optical probe.

During operation of probe systems 10, and as perhaps best illustrated in FIGS. 2-6, optical calibration structure 100 and optical probe assembly 30, and/or at least one optical probe 32 thereof, may be positioned, relative to one another, such that optical test beam 46 is incident upon optical calibration structure 100. The optical calibration structure then may be utilized to quantify at least one property of the optical test beam.

Chuck 20 may include any suitable structure that may define support surface 22 and/or that may support substrate 90 and/or one or more optical devices 92 thereof. As an example, chuck 20 may include and/or be a thermal chuck, which may be configured to control and/or to regulate a temperature of substrate 90 and/or of optical devices 92. In some such examples, and as illustrated in FIG. 1, chuck 20 may include a thermal control unit 24, which may be configured to regulate a temperature of the chuck and/or of the substrate. Additional examples of chuck 20 include a vacuum chuck and/or an electrically shielded chuck.

As illustrated in dashed lines in FIG. 1, probe system 10 and/or chuck 20 thereof may include a chuck translation structure 26. Chuck translation structure 26 may be configured to operatively translate chuck 20 relative to optical probe assembly 30 and/or to operatively rotate the chuck relative to the optical probe assembly. Such a configuration may permit and/or facilitate alignment, or optical alignment, between optical probes 32 of optical probe assembly 30 and optical devices 92 and/or optical calibration structure 100.

Optical probe assembly 30 may include any suitable structure that includes optical probe 32, that is configured to receive optical test beam 46 from signal generation and analysis assembly 40, that is configured to provide the optical test beam to optical device 92, that is configured to provide the optical test beam to optical calibration structure 100, that is configured to receive optical resultant beam 48 from optical device 92, and/or that is configured to provide the optical resultant beam to the signal generation and analysis assembly. Examples of optical probe 32 include a fiber optic probe, a polished fiber array, and/or a lensed fiber array. As discussed in more detail herein, optical probe assembly 30 may include a plurality of optical probes 32. Examples of the plurality of optical probes include at least 2, at least 4, at least 6, at least 8, at least 10, at most 50, at most 40, at most 30, at most 20, at most 15, at most 10, and/or at most 5 optical probes.

As illustrated in dashed lines in FIG. 1, optical probe assembly 30 may include a distance sensor 34. Distance sensor 34 may be configured to determine a distance between substrate 90 and optical probe assembly 30, and/or optical probe 32 thereof, such as when probe system 10 is utilized to optically test optical devices 92 of substrate 90. Stated differently, distance sensor 34 may, or may be utilized to, sense, determine, and/or calculate the distance between at least one component of optical probe assembly 30 and substrate 90, thereby permitting and/or facilitating determination of the distance between optical probe 32 and the substrate. Examples of distance sensor 34 include a capacitive distance sensor, a capacitive displacement sensor, an eddy current displacement sensor, a laser triangulation sensor, a confocal sensor, and/or a spectral interference displacement sensor.

As also illustrated in dashed lines in FIG. 1, probe system 10 and/or optical probe assembly 30 thereof may include an optical probe assembly translation structure 36. The optical probe assembly translation structure may be configured to operatively translate optical probe assembly 30 relative to chuck 20 and/or to operatively rotate the optical probe assembly relative to the chuck. Such a configuration may permit and/or facilitate alignment, or optical alignment, between optical probes 32 of optical probe assembly 30 and optical devices 92 and/or optical calibration structure 100.

As illustrated in FIGS. 1-6, and as discussed in more detail herein, optical calibration structure 100 includes a reflector 110 and an optical detector 130. It is within the scope of the present disclosure that optical probe assembly 30 may be configured to direct optical test beam 46 incident upon optical detector 130 along a corresponding beam path 47 that includes, or reflects from, reflector 110. Additionally or alternatively, optical probe assembly 30 may be configured to direct the optical test beam incident upon the optical detector along a corresponding beam path 47 that excludes, or is spaced apart from, the reflector, as perhaps best illustrated in FIG. 2.

It is within the scope of the present disclosure that optical probe assembly 30 may be configured to direct optical test beam 46 incident upon optical device 92 and/or to receive optical resultant beam 48 from the optical device in any suitable manner. As an example, optical probe assembly 30 may be configured for edge coupling between optical probes 32 and optical devices 92. Additionally or alternatively, optical probe assembly 30 may be configured for surface coupling between the optical probes and the optical devices.

Signal generation and analysis assembly 40 may include any suitable structure that may be adapted, configured, designed, and/or constructed to provide optical test beam 46 to optical probe 32 and/or to receive optical resultant beam 48 from the optical probe. An example of signal generation and analysis assembly 40 includes a light source 42, as illustrated in FIG. 1, which may be configured to generate the optical test beam. An example of the light source includes a laser light source. Another example of signal generation and analysis assembly 40 includes a light detector 44, which may be configured to receive the optical resultant beam, to detect the optical resultant beam, and/or to quantify at least one property of the optical resultant beam. Examples of the light detector include a photo detector and/or a photo diode.

As illustrated in dashed lines in FIG. 1, probe systems 10 may include at least one fiber optic cable 38. Fiber optic cable 38 may be configured to convey optical test beam 46 and/or optical resultant beam 48 between signal generation and analysis assembly 40 and optical probe assembly 30.

As illustrated in dashed lines in FIG. 1, and in some examples, probe systems 10 may include an imaging device 50. Imaging device 50, when present, may be positioned and/or configured to collect an optical image of chuck 20, of substrate 90, of optical device 92, of optical calibration structure 100, of optical probe assembly 30, and/or of optical probe 32. As an example, imaging device 50 may be configured to collect the optical image to permit and/or facilitate positioning and/or alignment between the optical probe and the optical device and/or between the optical probe and the optical calibration structure. Examples of the imaging device include a microscope 52, such as may include and/or be a digital microscope, a digital camera, and/or a digital video camera. An additional example of imaging device 50 includes an objective lens 54.

In some examples, imaging device 50 may be configured to generate an electronic representation of the optical image. In some such examples, probe systems 10 further may include a display 58, which may be configured to display the electronic representation of the optical image, such as to a user of the optical probe system.

As illustrated in dashed lines in FIG. 1, probe systems 10 and/or imaging device 50 thereof may include an imaging device translation structure 56. Imaging device translation structure 56 may be configured to operatively translate imaging device 50 relative to chuck 20, relative to optical probe assembly 30, and/or relative to optical calibration structure 100. Additionally or alternatively, imaging device translation structure 56 may be configured to operatively rotate the imaging device relative to the chuck, relative to the optical probe assembly, and/or relative to the optical calibration structure.

As illustrated in dashed lines in FIG. 1, probe systems 10 may include an enclosure 70. Enclosure 70 may define an enclosed volume 72, which may contain and/or house one or more other components of probe systems 10. As examples, at least a portion, a subset, and/or a region of one or more of support surface 22, chuck 20, optical probes 32, optical probe assembly 30, imaging device 50, substrate 90, and/or optical device 92 may be contained, housed, and/or positioned within the enclosed volume. Such a configuration may improve testing of optical devices 92 by probe systems 10, such as via increasing a signal-to-noise ratio of measurements performed on the optical devices by the probe systems and/or decreasing a sensitivity to an ambient environment that surrounds the probe system. Examples of enclosure 70 include a metallic enclosure 70, an electrically grounded enclosure 70, an electrically shielded enclosure 70, a magnetically shielded enclosure 70, an optically shielded enclosure 70, and/or a hermitically sealed enclosure 70.

Substrate 90 may include any suitable structure that may include optical devices 92, that may be operatively attached to optical devices 92, upon which optical devices 92 may be fabricated, and/or within which optical devices 92 may be fabricated. Examples of substrate 90 include a wafer and a semiconductor wafer. Similarly, optical devices 92 may include any suitable structure that may be tested by probe systems 10, that may receive optical test beam 46, and/or that may emit optical resultant beam 48. Examples of optical devices 92 include optoelectronic devices and/or silicon photonics devices.

As illustrated in dashed lines in FIG. 1, probe systems 10 may include an electric probe assembly 60. Electric probe assembly 60 may include at least one electric probe 62, which may be configured to electrically contact and/or to establish electric communication with optical device 92. As examples, electric probe 62 may be configured to provide an electric test signal to the optical device, to provide an electric power signal to the optical device, and/or to receive an electric resultant signal from the optical device.

As illustrated in dashed lines in FIG. 1, probe systems 10 may include a controller 80. Controller 80 may be programmed to control the operation of at least one other component of probe system 10. As an example, controller 80 may be programmed to control the operation of the at least one other component of probe systems 10 according to any suitable step and/or steps of methods 200, which are discussed in more detail herein. In some examples, controller 80 may be separate, distinct, and/or spaced apart from signal generation and analysis assembly 40. In some examples, controller 80 may be at least partially, or even completely, integral to and/or with signal generation and analysis assembly 40.

Controller 80 may include and/or be any suitable structure, device, and/or devices that may be adapted, configured, designed, constructed, and/or programmed to perform the functions discussed herein. As examples, controller 80 may include one or more of an electronic controller, a dedicated controller, a special-purpose controller, a personal computer, a special-purpose computer, a display device, a logic device, a memory device, and/or a memory device having computer-readable storage media.

The computer-readable storage media, when present, also may be referred to herein as non-transitory computer readable storage media 82. This non-transitory computer readable storage media may include, define, house, and/or store computer-executable instructions, programs, and/or code; and these computer-executable instructions may direct probe system 10 and/or controller 80 thereof to perform any suitable portion, or subset, of methods 200. Examples of such non-transitory computer-readable storage media include CD-ROMs, disks, hard drives, flash memory, etc. As used herein, storage, or memory, devices and/or media having computer-executable instructions, as well as computer-implemented methods and other methods according to the present disclosure, are considered to be within the scope of subject matter deemed patentable in accordance with Section 101 of Title 35 of the United States Code.

As illustrated in dashed lines in FIG. 1, probe systems 10 may include a calibration structure translation structure 170. Calibration structure translation structure 170 may be configured to operatively translate and/or to operatively rotate optical calibration structure 100 relative to optical probe assembly 30 and/or relative to optical probes 32 thereof. Such a configuration may permit and/or facilitate alignment, or optical alignment, between the optical probes and the optical calibration structure.

In the present disclosure, probe systems 10 are described as optionally including and/or utilizing a plurality of different, or distinct, translation structures, including chuck translation structure 26, optical probe assembly translation structure 36, imaging device translation structure 56, and/or calibration structure translation structure 170. These elements generally may be referred to herein as translation structures and may include any suitable component and/or components that may be utilized to provide the described motion, or relative motion, between and/or among two or more components of probe systems 10. Examples of the translation structures include an actuator, a mechanical actuator, an electrical actuator, a linear actuator, a rotary actuator, a rack and pinion assembly, a lead screw and nut assembly, a ball screw and nut assembly, a motor, a stepper motor, a servo motor, and/or a piezoelectric actuator. In some examples, functionality of two or more of the disclosed translation structures may be partially, or even completely, combined into a single translation structure. In some examples, two or more of the disclosed translation structures may include and/or utilize one or more common components, examples of which are disclosed herein.

Optical calibration structures 100 may include any suitable structure that may be positioned to receive optical test beam 46 from optical probe 32 and/or that may be configured to be utilized to calibrate optical probes 32 of optical probe systems 10. Optical calibration structures 100 may be incorporated into and/or utilized with optical probe systems 10 in any suitable manner. As an example, and as discussed, optical calibration structures 100 may be operatively attached to a remainder of optical probe systems 10 utilizing calibration structure translation structure 170. Such a configuration may permit and/or facilitate operative translation and/or rotation of optical calibration structures 100 relative to at least one other component of the optical probe system, such as optical probe assembly 30. As another example, and as illustrated in FIG. 1, optical calibration structures 100 may be incorporated into and/or may form a portion of an auxiliary chuck 102 of the optical probe system.

With continued reference to FIGS. 1-16, and with specific reference to FIG. 2, optical calibration structures 100 include reflector 110 and optical detector 130. Reflector 110 is configured to receive optical test beam 46 of electromagnetic radiation from optical probe 32 and to reflect the optical test beam as a reflected beam 118 of electromagnetic radiation, such as at a reflection angle 120 with respect to the optical test beam. Optical detector 130 is configured to receive reflected beam 118 and to produce a detector electrical output 132 that quantifies at least one property, or optical property, of the reflected beam.

The electromagnetic radiation defines beam path 47 between optical probe 32 and optical detector 130, such as may be defined by the combined paths of optical test beam 46 and reflected beam 118. In addition, optical calibration structure 100 includes an obstructive structure 140, which is positioned along beam path 47. Obstructive structure 140 also may be referred to herein as an electromagnetic radiation-blocking structure 140, an electromagnetic radiation-restricting structure 140, a partially transparent structure 140, a partially opaque structure 140, and/or a partially transparent and partially opaque structure 140. Obstructive structure 140 includes an unobstructed region 142, which is configured to permit electromagnetic radiation that is incident thereon to be received by the optical detector. The obstructive structure also includes an opaque region 150, which is configured to restrict electromagnetic radiation that is incident thereon from being received by the optical detector, such as via reflection and/or absorption of such electromagnetic radiation.

During operative use of optical calibration structures 100, and as discussed in more detail herein, at least one optical probe 32 of optical probe assembly 30 may direct a corresponding optical test beam 46 incident upon reflector 110. The optical test beam may be reflected, via the reflector, to define reflected beam 118, which may be incident upon optical detector 130, thereby permitting analysis of the reflected beam and/or quantification of at least one property of the reflected beam. As discussed, obstructive structure 140 is positioned along beam path 47, and electromagnetic radiation must pass through unobstructed region 142 of the obstructive structure in order to be incident upon the optical detector. This configuration provides several benefits. As an example, obstructive structure 140 may be utilized to restrict electromagnetic radiation that deviates significantly from beam path 47 from being incident upon optical detector 130, thereby permitting improved and/or higher sensitivity analysis of the reflected beam and/or quantification of the at least one property of the reflected beam. As another example, a shape of unobstructed region 142 may be selected to emphasize one or more properties of the reflected beam and/or to improve quantification of the at least one property of the reflected beam.

As yet another example, and as discussed in more detail herein, optical probe assembly 30 may include a plurality of optical probes 32, and obstructive structure 140 may be utilized to permit electromagnetic radiation emitted by one or more selected optical probes to be incident upon the optical detector while restricting electromagnetic radiation emitted by one or more other optical probes from being incident upon the optical detector, as perhaps best illustrated in FIGS. 5-6. Such a configuration may permit and/or facilitate quantification of the at least one property of the electromagnetic radiation emitted by each probe without a need to selectively restrict electromagnetic radiation from being emitted from individual probes, thereby decreasing overall costs of probe systems that include and/or utilize optical calibration structures 100, according to the present disclosure.

Reflector 110 may include any suitable structure that may be adapted, configured, designed, and/or constructed to receive optical test beam 46, to reflect the optical test beam as reflected beam 118, and/or to reflect the optical test beam at reflection angle 120. As an example, reflector 110 may include and/or be a reflective surface 112, which may be configured to reflect the optical test beam. Examples of the reflective surface include a metallic surface, a metal-coated surface, a silver surface, a silver-coated surface, a silver alloy surface, and/or a silver alloy-coated surface. As additional examples, reflector 110 may include and/or be a prism, a mirror, and/or a mirrored prism.

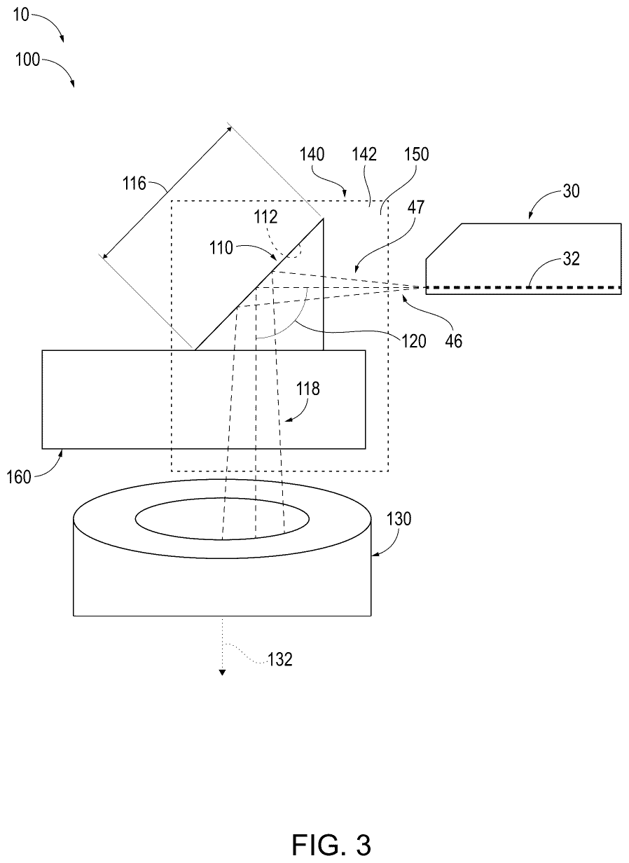

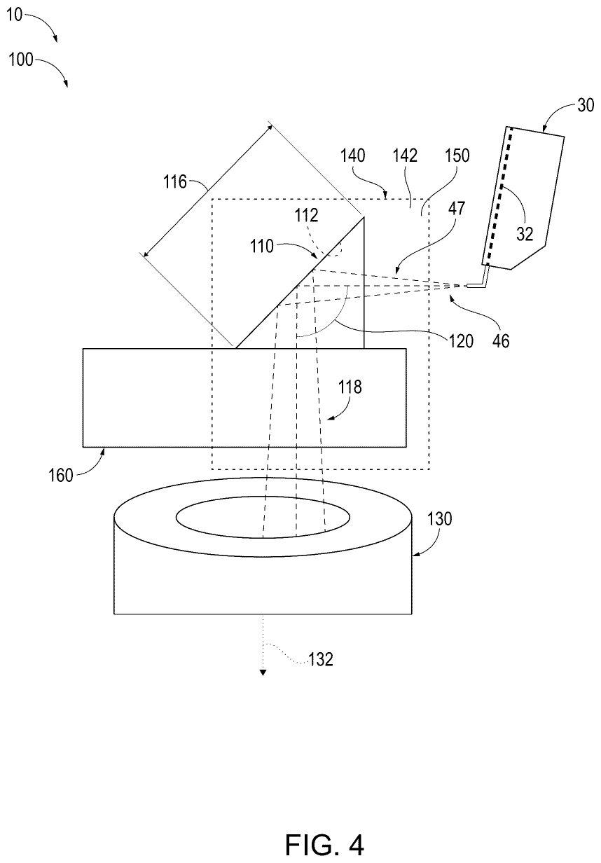

It is within the scope of the present disclosure that reflector 110 may be configured to receive optical test beam 46 along a horizontal, or at least substantially horizontal, region of beam path 47. Stated differently, optical probe 32 may be configured to emit optical test beam 46 horizontally, or at least substantially horizontally, toward and/or incident upon reflector 110. Additionally or alternatively, reflector 110 may be configured to reflect reflected beam 118 along a vertical, or at least substantially vertical, region of beam path 47. Stated differently, optical detector 130 may be configured to receive the reflected beam in a vertical, or at least substantially vertical, direction. Such a configuration may permit and/or facilitate operative use of optical calibration structures 100 with optical probes 32 that are configured for edge coupling with corresponding optical devices 92. As a more specific example, and as illustrated in FIG. 3, optical probes 32 may include and/or be a polished fiber array configured for edge coupling with optical devices 92. As another more specific example, and as illustrated in FIG. 4, optical probes 32 may include and/or be a lensed fiber array configured for edge coupling with the optical devices.

Reflector 110 may have and/or define any suitable reflection angle 120. Examples of reflection angle 120 include angles of at least 75 degrees, at least 80 degrees, at least 85 degrees, at least 90 degrees, at least 95 degrees, at least 100 degrees, at most 110 degrees, at most 105 degrees, at most 100 degrees, at most 95 degrees, at most 90 degrees, at most 85 degrees, and/or at most 80 degrees. In some examples, reflection angle 120 may be equal, or at least substantially equal, to 90 degrees.

Reflective surface 112 may have and/or define any suitable size and/or dimensions. As examples, reflective surface 112 may have a reflective surface width 116 and/or a reflective surface length 114, as collectively illustrated by FIGS. 2-6, of at least 0.25 millimeters (mm), at least 0.5 mm, at least 0.75 mm, at least 1 mm, at least 1.25 mm, at least 1.5 mm, at least 1.75 mm, at least 2 mm, at least 2.25 mm, at least 2.5 mm, at most 4 mm, at most 3.75 mm, at most 3.5 mm, at most 3.25 mm, at most 3 mm, at most 2.75 mm, at most 2.5 mm, at most 2.25 mm, at most 2 mm, at most 1.75 mm, at most 1.5 mm, at most 1.25 mm, and/or at most 1 mm.

Similarly, reflective surface 112 may have and/or define any suitable reflective surface area. Examples of the reflective surface area include at least 2 square millimeters (mm²), at least 2.5 mm², at least 3 mm², at least 3.5 mm², at least 4 mm², at least 4.5 mm², at least 5 mm², at most 10 mm², at most 8 mm², at most 6 mm², at most 5.5 mm², at most 5 mm², at most 4.5 mm², at most 4 mm², at most 3.5 mm², and/or at most 3 mm².

Optical calibration structure 100 may include any suitable number of reflectors 110. Stated differently, and for simplicity, FIGS. 2-6 only illustrate a single reflector 110; however, it is within the scope of the present disclosure that optical calibration structures 100 may include a plurality of reflectors 110, such as may be illustrated in FIGS. 1 and 12-15. Each reflector of the plurality of reflectors 110 may be configured to receive a corresponding optical test beam 46 of corresponding electromagnetic radiation from a corresponding optical probe 32 along a corresponding beam path 47 and to reflect the corresponding optical test beam as a corresponding reflected beam 118 and at a corresponding reflection angle 120 along the corresponding beam path. In such examples, optical calibration structure 100 may include a plurality of obstructive structures 140, with each obstructive structure of the plurality of obstructive structures being positioned along the corresponding beam path and being configured to permit electromagnetic radiation that travels along the corresponding beam path and is incident upon a corresponding unobstructed region 142 thereof to be received by the optical detector and to restrict electromagnetic radiation that is incident upon a corresponding opaque region 150 thereof from being received by the optical detector.

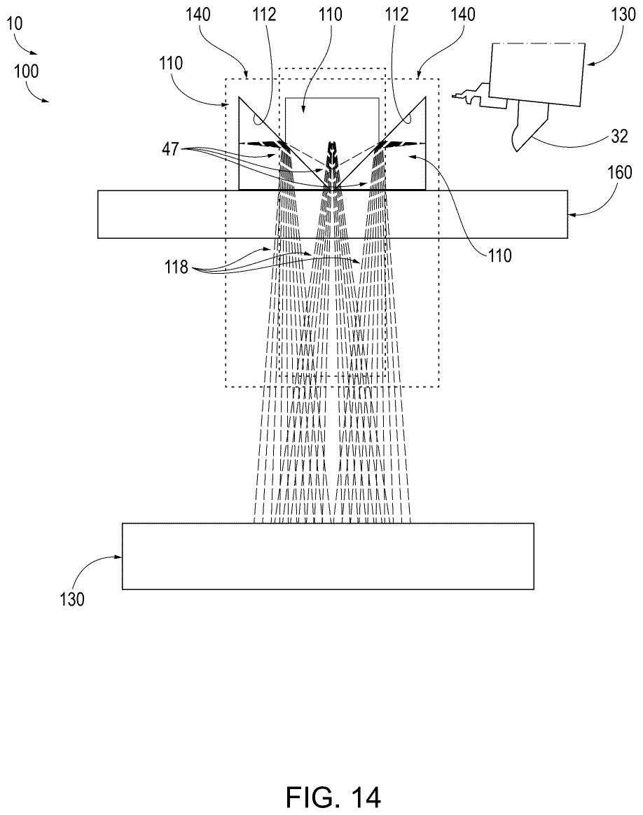

As perhaps best illustrated in FIGS. 13-14, the plurality of reflectors 110 may be positioned such that the corresponding reflected beam 118 of each reflector is incident upon optical detector 130. Additionally or alternatively, the plurality of reflectors 110 may be positioned such that the corresponding reflected beam of each reflector may extend parallel, or at least substantially parallel, to the corresponding reflected beam of each other reflector. Additionally or alternatively, the plurality of reflectors may be positioned such that the corresponding beam path 47 of the corresponding electromagnetic radiation incident upon each reflector extends from the corresponding optical probe and to the optical detector. Such a configuration may permit a single optical detector 130 to detect electromagnetic radiation reflected by the plurality of reflectors.

The plurality of reflectors may be oriented and/or positioned at any suitable relative orientation. As an example, and as perhaps best illustrated in FIGS. 12 and 14-15, two reflectors 110 of the plurality of reflectors may face away, or directly away, from one another. As another example, and as also illustrated in FIGS. 12 and 14-15, at least one reflector 110 of the plurality of reflectors may be oriented perpendicular, or at least substantially perpendicular, to at least one other reflector, or to the two reflectors that face away from one another.

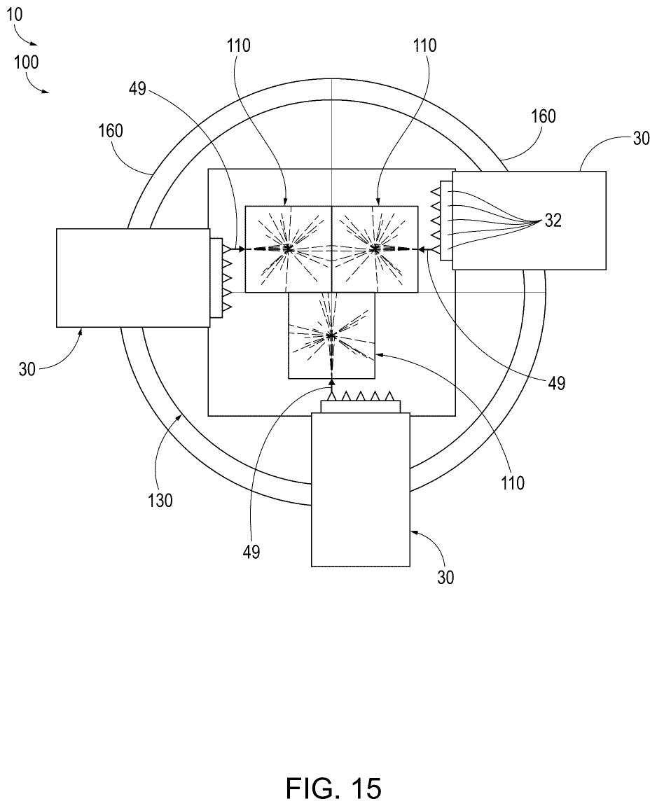

Each reflector 110 may be configured to receive the corresponding optical test beam 46 in and/or from a corresponding beam direction 49, as illustrated in FIG. 15. The corresponding beam direction of each reflector may extend parallel, or at least substantially parallel, to a beam direction plane. Stated differently, all optical test beams may extend parallel to and/or within a single plane, namely, the beam direction plane. The corresponding beam direction of two reflectors may extend toward one another. Additionally or alternatively, the corresponding beam direction of at least one reflector may extend perpendicular, or at least substantially perpendicular, to the corresponding beam direction of at least one other reflector, as also illustrated in FIG. 15.

The plurality of reflectors may include any suitable number of reflectors. In a specific example, and as illustrated, the plurality of reflectors may include three, or exactly three, reflectors. Such a configuration may permit optical detector 130 to detect electromagnetic radiation emitted from corresponding optical probes 32 in three different directions while, at the same time, providing space for electrical connections between the probe system and the optical device.

Optical detector 130 may include any suitable structure that may be adapted, configured, designed, and/or constructed to receive reflected beam 118, to analyze the reflected beam, and/or to produce detector electrical output 132. Examples of optical detector 130 include an intensity meter, a power meter, and/or a beam profiler.

Obstructive structure 140 may include any suitable structure that may be adapted, configured, designed, and/or constructed to include unobstructed region 142, to include opaque region 150, to permit electromagnetic radiation that is incident upon the unobstructed region to pass therethrough, and/or to restrict electromagnetic radiation that is incident upon the opaque region from passing therethrough. As an example, unobstructed region 142 may be transparent, or at least substantially transparent, to electromagnetic radiation, to optical test beam 46, and/or at a frequency and/or wavelength of the optical test beam. As another example, obstructive structure 140 may be configured to absorb electromagnetic radiation that is incident upon opaque region 150. As another example, obstructive structure 140 may be configured to reflect electromagnetic radiation that is incident upon opaque region 150. As another example, obstructive structure 140 may be configured to scatter electromagnetic radiation that is incident upon opaque region 150. As yet another example, opaque region 150 may be opaque, or at least substantially opaque, to the electromagnetic radiation.

Obstructive structure 140 may be configured in any suitable manner. As an example, and as illustrated in FIGS. 7-11, opaque region 150 may bound, at least partially bound, surround, at least partially surround, extend around, and/or extend at least partially around unobstructed region 142 and/or a transverse cross-section of beam path 47.

Obstructive structure 140 may be positioned at any suitable location along beam path 47. As an example, the obstructive structure may be positioned between optical probe 32 and reflector 110. Stated differently, the obstructive structure may be positioned along a length of optical test beam 46. As another example, obstructive structure 140 may be positioned between reflector 110 and optical detector 130. Stated differently, the obstructive structure may be positioned along a length of reflected beam 118. As more specific examples, obstructive structure 140 may be positioned and/or defined on a face of a prism that defines reflector 110 and/or may be positioned within the prism.

Unobstructed region 142 may have and/or define any suitable shape. As an example, unobstructed region 142 may include and/or be an unobstructed opening that is configured to permit the electromagnetic radiation to pass therethrough. As additional examples, unobstructed region 142 may include and/or be an unobstructed pinhole structure, an unobstructed slit structure, and/or an unobstructed rectangular slit structure. More specific examples of geometries of unobstructed region 142 are illustrated in FIGS. 7-11 and include rectilinear, at least partially rectilinear, rectangular, at least partially rectangular, square, at least partially square, oval, at least partially oval, circular, and/or at least partially circular geometries.

Unobstructed region 142 may have and/or define any suitable size and/or dimensions. As an example, the unobstructed region may define an unobstructed region width 146 of at least 20 micrometers, at least 25 micrometers, at least 30 micrometers, at least 35 micrometers, at least 40 micrometers, at least 45 micrometers, at least 50 micrometers, at least 55 micrometers, at least 60 micrometers, at most 80 micrometers, at most 75 micrometers, at most 70 micrometers, at most 65 micrometers, at most 60 micrometers, at most 55 micrometers, at most 50 micrometers, at most 45 micrometers, and/or at most 40 micrometers. As another example, the unobstructed region may define an unobstructed region height 148 of at least 70 micrometers, at least 75 micrometers, at least 80 micrometers, at least 85 micrometers, at least 90 micrometers, at least 95 micrometers, at least 100 micrometers, at least 105 micrometers, at least 110 micrometers, at most 130 micrometers, at most 125 micrometers, at most 120 micrometers, at most 115 micrometers, at most 110 micrometers, at most 105 micrometers, at most 100 micrometers, at most 95 micrometers, and/or at most 90 micrometers.

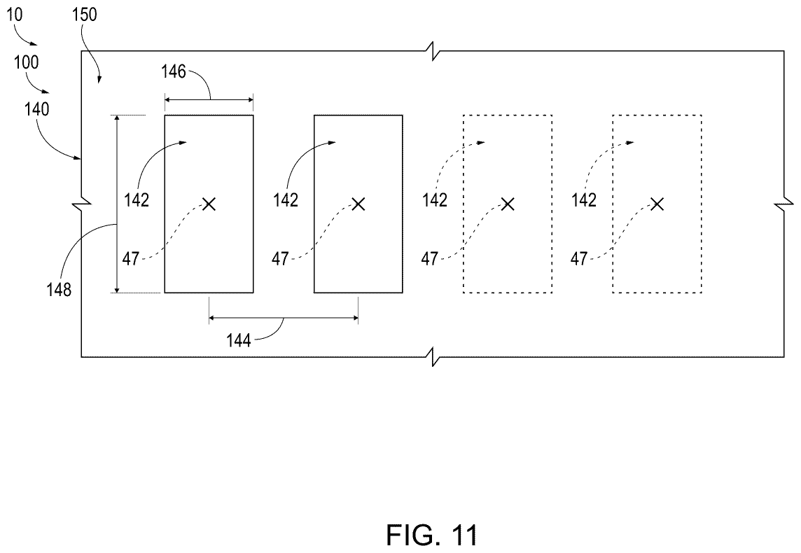

It is within the scope of the present disclosure that obstructive structure 140 may include any suitable number of unobstructed regions 142. As an example, and as illustrated in FIGS. 7-10, the obstructive structure may include a single unobstructed region. As another example, and as illustrated in FIG. 11, the obstructive structure may include a plurality of distinct and/or spaced apart unobstructed regions 142. In a more specific example, optical probe assembly 30 may include a plurality of optical probes 32, which may define a probe pitch 33, as illustrated in FIG. 1. In such examples, unobstructed regions 142 may define an unobstructed region pitch 144, as illustrated in FIG. 11. The unobstructed region pitch may correspond to the probe pitch. As an example, the unobstructed region pitch may be equal to the probe pitch. As another example, the unobstructed region pitch may be an integer multiple of the probe pitch. Such a configuration may permit obstructive structures 140 with plural unobstructed regions 142 to permit electromagnetic radiation emitted by selected optical probes 32 to be incident upon optical detector 130 while restricting electromagnetic radiation emitted by other probes 32 from being incident upon the optical detector, as discussed in more detail herein.

The plurality of unobstructed regions may be arranged in any suitable orientation, or relative orientation. As examples, the plurality of unobstructed regions may be arranged in a row, in a single row, and/or in a plurality of spaced apart rows.

As illustrated in dashed lines in FIGS. 1-2 and in solid lines in FIGS. 3-6 and 12-15, optical calibration structures 100 may include a sheet of transparent material 160. The sheet of transparent material may be positioned along beam path 47 and/or may be transparent, or at least substantially transparent, to the electromagnetic radiation. In some examples, one or more reflectors 110 may be operatively attached to, defined by, and/or mounted on sheet of transparent material 160. In some examples, the sheet of transparent material may extend between the one or more reflectors and optical detector 130. In some examples, obstructive structure 140 may be operatively attached to the sheet of transparent material, may be at least partially defined by the sheet of transparent material, may be defined on a surface of the sheet of transparent material, and/or may be defined within the sheet of transparent material. An example of sheet of transparent material 160 includes a sheet of transparent glass, a sheet of optically transparent glass, and/or a sheet of glass that is transparent at a frequency and/or wavelength of the electromagnetic radiation.

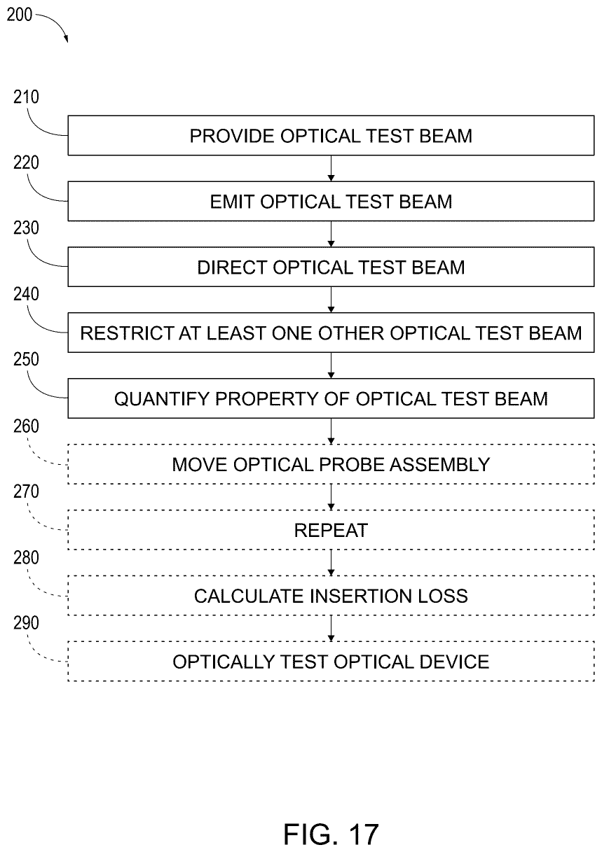

FIG. 17 is a flowchart depicting examples of methods 200 of calibrating a plurality of optical probes of an optical probe assembly of an optical probe system, according to the present disclosure. The optical probe system includes an optical calibration structure that includes a reflector, an optical detector, and an obstructive structure. Examples of the plurality of optical probes, the optical probe assembly, and the optical probe system are disclosed herein with reference to optical probes 32, optical probe assembly 30, and optical probe system 10, respectively. Examples of the optical calibration structure, the reflector, the optical detector, and the obstructive structure are disclosed herein with reference to optical calibration structure 100, reflector 110, optical detector 130, and obstructive structure 140, respectively.

Methods 200 include providing an optical test beam at 210, emitting the optical test beam at 220, and directing the optical test beam at 230. Methods 200 also include restricting at least one other optical test beam at 240 and quantifying a property of the optical test beam at 250. Methods 200 further may include moving an optical probe assembly at 260, repeating at 270, calculating an insertion loss at 280, and/or optically testing an optical device at 290.

Providing the optical test beam at 210 includes simultaneously providing a corresponding optical test beam of electromagnetic radiation to each optical probe of the plurality of optical probes. This may be accomplished in any suitable manner. As an example, the providing at 210 may include providing the corresponding optical test beam with, via, and/or utilizing a signal generation and analysis assembly of the optical probe system. Examples of the optical test beam and of the signal generation and analysis assembly are disclosed herein with reference to optical test beam 46 and signal generation and analysis assembly 40, respectively.

Emitting the optical test beam at 220 includes simultaneously emitting the corresponding optical test beam from each optical probe. This may include simultaneously emitting the corresponding optical test beam from each optical probe along a corresponding beam path, examples of which are disclosed herein with reference to beam path 47. The emitting at 220 may be subsequent to and/or responsive to the providing at 210.

Directing the optical test beam at 230 may include directing the corresponding optical test beam of a selected optical probe of the plurality of optical probes along the corresponding beam path that extends through the obstructive structure, is reflected by the reflector, and is incident upon the optical detector. This is illustrated, for example, in FIG. 5. In some examples, the directing at 230 may include simultaneously directing the corresponding optical test beam of each optical probe of a plurality of selected optical probes along a corresponding beam path that extends through the obstructive structure, is reflected by the reflector, and is incident upon the detector. This is illustrated, for example, in FIG. 6.

Restricting at least one other optical test beam at 240 may include restricting at least one other corresponding optical test beam of at least one other optical probe of the plurality of optical probes from being incident upon the optical detector. The restricting at 240 may be performed concurrently with the directing at 230. Additionally or alternatively, the restricting at 240 may include restricting with, via, and/or utilizing the obstructive structure. This is illustrated, for example, in FIGS. 5-6, wherein one or more optical test beams 46 pass through obstructive structure 140, such as via corresponding unobstructed regions 142 thereof, and are incident upon optical detector 130, while the remaining optical test beams 46 are restricted by the obstructive structure and/or are not incident upon the optical detector.

Quantifying the property of the optical test beam at 250 may include quantifying at least one property of the corresponding optical test beam of the selected optical probe. The quantifying at 250 may be performed with, via, and/or utilizing the optical detector. It is within the scope of the present disclosure that the quantifying at 250 may include establishing, determining, calculating, and/or estimating any suitable property of the corresponding optical test beam. Examples of the property of the corresponding optical test beam include an intensity of the corresponding optical test beam, an optical power of the corresponding optical test beam, a frequency of the corresponding optical test beam, a wavelength of the corresponding optical test beam, a phase of the corresponding optical test beam, a polarity of the corresponding optical test beam, a beam profile of the corresponding optical test beam, a beam intensity profile of the corresponding optical test beam, and/or a beam shape of the corresponding optical test beam.

When the directing at 230 includes simultaneously directing the corresponding optical test beam of each optical probe of a plurality of selected optical probes along a corresponding beam path that extends through the obstructive structure, is reflected by the reflector, and is incident upon the detector, the quantifying at 250 may include quantifying a composite optical property of the corresponding optical test beam of the plurality of selected optical probes. Such a configuration may permit and/or facilitate comparison of individually quantified optical properties of individually selected optical probes with composite optical properties of the plurality of selected optical probes, which may provide additional information regarding the optical properties of the plurality of optical probes and/or may permit verification of the individually quantified optical properties.

The selected optical probe may include and/or be a first selected optical probe. With this in mind, the moving the optical probe assembly at 260 may include moving the optical probe assembly and the optical calibration structure relative to one another such that a corresponding beam path of a corresponding test beam of a second selected optical probe of the plurality of optical probes extends through the obstructive structure, is reflected by the reflector, and is incident upon the optical detector. This may include moving such that the corresponding beam path of the first selected optical probe is restricted by the obstructive structure and/or is no longer incident upon the optical detector.

Repeating at 270 may include repeating the quantifying at 250 to quantify the at least one property of the corresponding optical test beam of the second selected optical probe utilizing the optical detector. In some examples, the repeating at 270 may include repeatedly performing the moving at 260 and the quantifying at 250 a plurality of times to quantify the at least one property of each optical probe of the plurality of optical probes.

Calculating the insertion loss at 280 may include calculating a corresponding insertion loss for each optical probe of the plurality of optical probes. This may include calculating the corresponding insertion loss based, at least in part, on the quantifying at 250 and/or on the at least one property of the selected optical probe that is determined during the quantifying at 250, such as for each optical probe. Examples of the insertion loss include a decrease in intensity of the corresponding optical test beam and/or a decrease in optical power of the corresponding optical test beam upon being conveyed through the corresponding optical probe of the plurality of optical probes.

Optically testing the optical device at 290 may include optically testing the optical device utilizing the optical probe system. This may include optically testing the optical device and subsequently determining at least one optical characteristic of the optical device. In some examples, the optically testing at 290 further may include adjusting the at least one optical characteristic of the optical device that is determined during the determining. The adjusting may be based, at least in part, on the at least one property of the corresponding optical test beam of the selected optical probe, the at least one property of each optical probe of the plurality of optical probes, and/or the corresponding insertion loss for each optical probe of the plurality of optical probes. Stated differently, performing the quantifying at 250 and/or the calculating at 280 prior to performing the optically testing at 290 may permit and/or facilitate improved optical testing of the optical device, such as via permitting improved quantification and/or characterization of differences among the plurality of optical probes and/or adjusting to account for the differences among the plurality of optical probes.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of optical calibration structures, optical probe systems, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. An optical calibration structure for an optical probe of an optical probe system, the optical calibration structure comprising:
a reflector configured to receive an optical test beam of electromagnetic radiation from the optical probe and to reflect the optical test beam as a reflected beam and at a reflection angle with respect to the optical test beam; and
an optical detector configured to receive the reflected beam and to produce a detector electrical output that quantifies at least one property of the reflected beam;
wherein the electromagnetic radiation defines a beam path between the optical probe and the optical detector; and
wherein the optical calibration structure further includes an obstructive structure positioned along the beam path, wherein the obstructive structure includes an unobstructed region configured to permit electromagnetic radiation that is incident thereon to be received by the optical detector and an opaque region configured to restrict electromagnetic radiation that is incident thereon from being received by the optical detector.

A2. The optical calibration structure of paragraph A1, wherein the reflector includes, or is, at least one of a prism, a mirror, and/or a mirrored prism.

A3. The optical calibration structure of any of paragraphs A1-A2, wherein the reflector is configured to receive the optical test beam along a horizontal, or at least substantially horizontal, region of the beam path.

A4. The optical calibration structure of any of paragraphs A1-A3, wherein the reflector is configured to reflect the reflected beam along a vertical, or at least substantially vertical, region of the beam path.

A5. The optical calibration structure of any of paragraphs A1-A4, wherein the reflector includes a reflective surface optionally configured to reflect the optical test beam.

A6. The optical calibration structure of paragraph A5, wherein the reflective surface includes at least one of a metallic surface, a silver surface, and a silver alloy surface.

A7. The optical calibration structure of any of paragraphs A5-A6, wherein the reflective surface defines at least one of a reflective surface width and a reflective surface length of at least one of:
(i) at least 0.25 millimeters (mm), at least 0.5 mm, at least 0.75 mm, at least 1 mm, at least 1.25 mm, at least 1.5 mm, at least 1.75 mm, at least 2 mm, at least 2.25 mm, or at least 2.5 mm; and
(ii) at most 4 mm, at most 3.75 mm, at most 3.5 mm, at most 3.25 mm, at most 3 mm, at most 2.75 mm, at most 2.5 mm, at most 2.25 mm, at most 2 mm, at most 1.75 mm, at most 1.5 mm, at most 1.25 mm, or at most 1 mm.

A8. The optical calibration structure of any of paragraphs A5-A7, wherein the reflective surface defines a reflective surface area of at least one of:
(i) at least 2 square millimeters (mm²), at least 2.5 mm², at least 3 mm², at least 3.5 mm², at least 4 mm², at least 4.5 mm², or at least 5 mm²; and
(ii) at most 10 mm², at most 8 mm², at most 6 mm², at most 5.5 mm², at most 5 mm², at most 4.5 mm², at most 4 mm², at most 3.5 mm², or at most 3 mm².

A9. The optical calibration structure of any of paragraphs A1-A8, wherein the reflection angle is at least one of:
(i) at least 75 degrees, at least 80 degrees, at least 85 degrees, at least 90 degrees, at least 95 degrees, or at least 100 degrees;
(ii) at most 110 degrees, at most 105 degrees, at most 100 degrees, at most 95 degrees, at most 90 degrees, at most 85 degrees, or at most 80 degrees; or
(iii) equal, or at least substantially equal, to 90 degrees.

A10. The optical calibration structure of any of paragraphs A1-A9, wherein the optical calibration structure includes a plurality of reflectors, wherein each reflector of the plurality of reflectors is configured to receive a corresponding optical test beam of corresponding electromagnetic radiation from a corresponding optical probe along a corresponding beam path and to reflect the corresponding optical test beam as a corresponding reflected beam and at a corresponding reflection angle along the corresponding beam path, wherein the optical calibration structure further includes a plurality of obstructive structures, and further wherein each obstructive structure of the plurality of obstructive structures is positioned along the corresponding beam path and is configured to permit electromagnetic radiation that travels along the corresponding beam path and is incident upon a corresponding unobstructed region to be received by the optical detector and to restrict electromagnetic radiation that is incident upon a corresponding opaque region from being received by the optical detector.

A11. The optical calibration structure of paragraph A10, wherein the plurality of reflectors is positioned such that the corresponding reflected beam of each reflector is incident upon the optical detector.

A12. The optical calibration structure of any of paragraphs A10-A11, wherein the plurality of reflectors is positioned such that the corresponding reflected beam reflected by each reflector extends parallel, or at least substantially parallel, to the corresponding reflected beam reflected by each other reflector of the plurality of reflectors.

A13. The optical calibration structure of any of paragraphs A10-A12, wherein the plurality of reflectors is positioned such that the corresponding beam path of the corresponding electromagnetic radiation for each reflector extends from the corresponding optical probe to the optical detector.

A14. The optical calibration structure of any of paragraphs A10-A13, wherein two reflectors of the plurality of reflectors face away, or directly away, from one another.

A15. The optical calibration structure of any of paragraphs A10-A14, wherein at least one reflector of the plurality of reflectors is oriented perpendicular, or at least substantially perpendicular, with respect to at least one other reflector of the plurality of reflectors.

A16. The optical calibration structure of any of paragraphs A10-A15, wherein each reflector is configured to receive the corresponding optical test beam in a corresponding beam direction.

A17. The optical calibration structure of paragraph A16, wherein the corresponding beam direction of each reflector extends parallel, or at least substantially parallel, to a beam direction plane.

A18. The optical calibration structure of any of paragraphs A16-A17, wherein the corresponding beam direction of two reflectors of the plurality of reflectors extends toward one another.

A19. The optical calibration structure of any of paragraphs A16-A18, wherein the corresponding beam direction of at least one reflector of the plurality of reflectors is oriented perpendicular, or at least substantially perpendicular, with respect to at least one other reflector of the plurality of reflectors.

A20. The optical calibration structure of any of paragraphs A10-A19, wherein the plurality of reflectors includes three, or exactly three, reflectors.

A21. The optical calibration structure of any of paragraphs A1-A20, wherein the optical detector includes, or is, at least one of an intensity meter and a power meter.

A22. The optical calibration structure of any of paragraphs A1-A21, wherein the optical detector includes, or is, a beam profiler.

A23. The optical calibration structure of any of paragraphs A1-A22, wherein the obstructive structure is configured to absorb electromagnetic radiation that is incident upon the opaque region.

A24. The optical calibration structure of any of paragraphs A1-A23, wherein the obstructive structure is configured to reflect electromagnetic radiation that is incident upon the opaque region.

A25. The optical calibration structure of any of paragraphs A1-A24, wherein the unobstructed region is transparent, or at least substantially transparent, to the electromagnetic radiation, optionally wherein the beam path extends through the unobstructed region.

A26. The optical calibration structure of any of paragraphs A1-A25, wherein the opaque region is opaque, or at least substantially opaque, to the electromagnetic radiation, wherein the opaque region at least one of:
(i) bounds the unobstructed region; and
(ii) extends around a transverse cross-section of the beam path.

A27. The optical calibration structure of any of paragraphs A1-A26, wherein the obstructive structure is at least one of:
(i) positioned between the optical probe and the reflector; and
(ii) positioned along the beam path of the optical test beam.

A28. The optical calibration structure of any of paragraphs A1-A27, wherein the obstructive structure is at least one of:
(i) positioned between the reflector and the optical detector; and
(ii) positioned along the beam path of the optical test beam.

A29. The optical calibration structure of any of paragraphs A1-A28, wherein the obstructive structure is at least one of:
(i) positioned at the reflector;
(ii) positioned on a face of a/the prism that defines the reflector; and
(iii) positioned within the prism.

A30. The optical calibration structure of any of paragraphs A1-A29, wherein the unobstructed region includes an unobstructed opening configured to permit the electromagnetic radiation to pass therethrough.

A31. The optical calibration structure of any of paragraphs A1-A30, wherein the unobstructed region includes an unobstructed pinhole structure.

A32. The optical calibration structure of any of paragraphs A1-A31, wherein the unobstructed region includes an unobstructed slit structure or a rectangular unobstructed slit structure.

A33. The optical calibration structure of any of paragraphs A1-A32, wherein the unobstructed region defines an unobstructed region width of at least one of:
(i) at least 20 micrometers, at least 25 micrometers, at least 30 micrometers, at least 35 micrometers, at least 40 micrometers, at least 45 micrometers, at least 50 micrometers, at least 55 micrometers, or at least 60 micrometers; and
(ii) at most 80 micrometers, at most 75 micrometers, at most 70 micrometers, at most 65 micrometers, at most 60 micrometers, at most 55 micrometers, at most 50 micrometers, at most 45 micrometers, or at most 40 micrometers.

A34. The optical calibration structure of any of paragraphs A1-A33, wherein the unobstructed region defines an unobstructed region height of at least one of:
(i) at least 70 micrometers, at least 75 micrometers, at least 80 micrometers, at least 85 micrometers, at least 90 micrometers, at least 95 micrometers, at least 100 micrometers, at least 105 micrometers, or at least 110 micrometers; and
(ii) at most 130 micrometers, at most 125 micrometers, at most 120 micrometers, at most 115 micrometers, at most 110 micrometers, at most 105 micrometers, at most 100 micrometers, at most 95 micrometers, or at most 90 micrometers.

A35. The optical calibration structure of any of paragraphs A1-A34, wherein the obstructive structure includes a plurality of spaced apart unobstructed regions.

A36. The optical calibration structure of paragraph A35, wherein the optical probe system includes an optical probe assembly that includes a plurality of optical probes, wherein the plurality of optical probes defines a probe pitch, or an average probe pitch, wherein the plurality of spaced apart unobstructed regions defines an unobstructed region pitch, or an average unobstructed region pitch, and further wherein at least one of:
(i) the unobstructed region pitch is equal, or at least substantially equal, to the probe pitch; and
(ii) the unobstructed region pitch is an integer multiple of the probe pitch.

A37. The optical calibration structure of any of paragraphs A35-A36, wherein the plurality of spaced apart unobstructed regions is arranged in a row, or in a single row.

A38. The optical calibration structure of any of paragraphs A1-A37, wherein the optical calibration structure further includes a sheet of transparent material, which is transparent, or at least substantially transparent, to the electromagnetic radiation, wherein the reflector is at least one of operatively attached to the sheet of transparent material and at least partially defined by the sheet of transparent material.

A39. The optical calibration structure of paragraph A38, wherein the sheet of transparent material extends between the reflector and the optical detector.

A40. The optical calibration structure of any of paragraphs A38-A39, wherein the obstructive structure is at least one of operatively attached to the sheet of transparent material, at least partially defined by the sheet of transparent material, defined on a surface of the sheet of transparent material, and defined within the sheet of transparent material.

A41. The optical calibration structure of any of paragraphs A38-A40, wherein the sheet of transparent material includes, or is, a sheet of transparent glass.

B1. An optical probe system, comprising:
a chuck that defines a support surface configured to support a substrate that includes a plurality of optical devices;
an optical probe assembly including an optical probe;
a signal generation and analysis assembly configured to at least one of provide an optical test beam to the optical probe and receive an optical resultant beam from the optical probe; and
the optical calibration structure of any of paragraphs A1-A41, wherein the optical calibration structure is positioned to receive the optical test beam from the optical probe.

B2. The optical probe system of paragraph B1, wherein the chuck includes a thermal control unit configured to regulate a temperature of the substrate.

B3. The optical probe system of any of paragraphs B1-B2, wherein the optical probe system further includes a chuck translation structure configured to at least one of:
(i) operatively translate the chuck relative to the optical probe assembly; and
(ii) operatively rotate the chuck relative to the optical probe assembly.

B4. The optical probe system of any of paragraphs B1-B3, wherein the optical probe includes at least one of:
(i) a fiber optic probe;
(ii) a polished fiber array; and
(iii) a lensed fiber array.

B5. The optical probe system of any of paragraphs B1-B4, wherein the optical probe assembly includes a/the plurality of optical probes.

B6. The optical probe system of any of paragraphs B1-B5, wherein the optical probe assembly further includes a distance sensor configured to determine a distance between the optical probe and the substrate when the optical probe system is utilized to optically test at least one optical device of the substrate.

B7. The optical probe system of paragraph B6, wherein the distance sensor includes at least one of a capacitive distance sensor, a capacitive displacement sensor, an eddy current displacement sensor, a laser triangulation sensor, a confocal sensor, and/or a spectral interference displacement sensor.

B8. The optical probe system of any of paragraphs B1-B7, wherein the optical probe system further includes an optical probe assembly translation structure configured to at least one of:
(i) operatively translate the optical probe assembly relative to the chuck; and
(ii) operatively rotate the optical probe assembly relative to the chuck.

B9. The optical probe system of any of paragraphs B1-B8, wherein the optical probe assembly is configured for edge coupling between the optical probe and a given optical device of the plurality of optical devices.

B10. The optical probe system of any of paragraphs B1-B9, wherein the optical probe assembly is configured to direct the optical test beam incident upon the optical detector along a corresponding beam path that includes a reflector.

B11. The optical probe system of any of paragraphs B1-B10, wherein the optical probe assembly is configured for surface coupling between the optical probe and a/the given optical device of the plurality of optical devices.

B12. The optical probe system of any of paragraphs B1-B11, wherein the optical probe assembly is configured to direct the optical test beam incident upon the optical detector along a corresponding beam path that excludes the reflector.

B13. The optical probe system of any of paragraphs B1-B12, wherein the signal generation and analysis assembly includes a light source configured to generate the optical test beam.

B14. The optical probe system of paragraph B13, wherein the light source includes a laser light source.

B15. The optical probe system of any of paragraphs B13-B14, wherein the signal generation and analysis assembly includes a light detector configured to detect the optical resultant beam.

B16. The optical probe system of paragraph B15, wherein the light detector includes at least one of a photo detector and a photo diode.

B17. The optical probe system of any of paragraphs B1-B16, wherein the optical probe system further includes an imaging device positioned to collect an optical image of at least one of the chuck and the optical probe.

B18. The optical probe system of paragraph B17, wherein the imaging device includes a microscope.

B19. The optical probe system of any of paragraphs B17-B18, wherein the imaging device includes an objective lens.

B20. The optical probe system of any of paragraphs B17-B19, wherein the imaging device is configured to receive an optical image and to generate an electronic representation of the optical image.

B21. The optical probe system of paragraph B20, wherein the optical probe system further includes a display configured to display the electronic representation of the optical image to a user of the optical probe system.

B22. The optical probe system of any of paragraphs B17-B21, wherein the optical probe system further includes an imaging device translation structure configured to at least one of:
(i) operatively translate the imaging device relative to the chuck;
(ii) operatively rotate the imaging device relative to the chuck;
(iii) operatively translate the imaging device relative to the optical probe assembly; and
(iv) operatively rotate the imaging device relative to the optical probe assembly.

B23. The optical probe system of any of paragraphs B1-B22, wherein the optical probe system further includes a fiber optic cable configured to convey at least one of the optical test beam and the optical resultant beam between the signal generation and analysis assembly and the optical probe assembly.

B24. The optical probe system of any of paragraphs B1-B23, wherein the optical probe system further includes an enclosure that defines an enclosed volume, wherein at least the support surface of the chuck is positioned within the enclosed volume.

B25. The optical probe system of any of paragraphs B1-B24, wherein the substrate includes a semiconductor wafer, optionally wherein the optical probe system includes the semiconductor wafer.

B26. The optical probe system of any of paragraphs B1-B25, wherein the plurality of optical devices includes a plurality of silicon photonics optical devices.

B27. The optical probe system of any of paragraphs B1-B26, wherein the optical probe system further includes an electric probe assembly that includes at least one electric probe configured to electrically contact a/the given optical device of the plurality of optical devices and to at least one of:
(i) provide an electric test signal to the given optical device;
(ii) receive an electric resultant signal from the given optical device; and
(iii) provide an electric power signal to the given optical device.

B28. The optical probe system of any of paragraphs B1-B27, wherein the optical probe system further includes a controller programmed to control the operation of the optical probe system according to any suitable step and/or steps of any of the methods of any of paragraphs C1-C8.

B29. The optical probe system of any of paragraphs B1-B28, wherein the optical probe system further includes a calibration structure translation structure configured to at least one of:
(i) operatively translate the optical calibration structure relative to the optical probe assembly; and
(ii) operatively rotate the optical calibration structure relative to the optical probe assembly.

C1. A method of calibrating a plurality of optical probes of an optical probe assembly of an optical probe system, wherein the optical probe system includes an optical calibration structure that includes a reflector, an optical detector, and an obstructive structure, the method comprising:
simultaneously providing a corresponding optical test beam of electromagnetic radiation to each optical probe of the plurality of optical probes;
responsive to the simultaneously providing, simultaneously emitting the corresponding optical test beam from each optical probe;
directing the corresponding optical test beam of a selected optical probe of the plurality of optical probes along a corresponding beam path that extends through the obstructive structure, is reflected by the reflector, and is incident upon the optical detector;
concurrently with the directing and utilizing the obstructive structure, restricting at least one other corresponding optical test beam of at least one other optical probe of the plurality of optical probes from being incident upon the optical detector; and
quantifying at least one property of the corresponding optical test beam of the selected optical probe utilizing the optical detector.

C2. The method of paragraph C1, wherein the selected optical probe is a first selected optical probe, and further wherein the method includes:
(i) moving the optical probe assembly and the optical calibration structure relative to one another such that a corresponding beam path of the corresponding optical test beam of a second selected optical probe extends through the obstructive structure, is reflected by the reflector, and is incident upon the optical detector; and
(ii) repeating the quantifying to quantify the at least one property of the corresponding optical test beam of the second selected optical probe utilizing the optical detector.

C3. The method of any of paragraphs C1-C2, wherein the method further includes repeatedly performing the moving and the repeating the quantifying to quantify the at least one property of each optical probe of the plurality of optical probes.

C4. The method of any of paragraphs C1-C3, wherein:
the directing the corresponding optical test beam includes simultaneously directing the corresponding optical test beam of each optical probe of a plurality of selected optical probes along a corresponding beam path that extends through the obstructive structure, is reflected by the reflector, and is incident upon the detector; and
the quantifying the at least one property of the corresponding optical test beam includes quantifying a composite optical property of the corresponding optical test beam of the plurality of selected optical probes.

C5. The method of any of paragraphs C1-C4, wherein the method further includes calculating a corresponding insertion loss for each optical probe.

C6. The method of any of paragraphs C1-C5, wherein the method further includes optically testing an optical device utilizing the optical probe system and determining at least one optical characteristic of the optical device, wherein the optical testing includes adjusting the at least one optical characteristic of the optical device based, at least in part, on at least one of:
(i) the at least one property of the corresponding optical test beam of the selected optical probe;
(ii) a/the at least one property of each optical probe of the plurality of optical probes; and
(iii) a/the corresponding insertion loss for each optical probe of the plurality of optical probes.

C7. The method of any of paragraphs C1-C6, wherein the optical probe system includes any suitable structure, function, and/or feature of any of the optical probe systems of any of paragraphs B1-B29.

C8. The method of any of paragraphs C1-C7, wherein the optical calibration structure includes any suitable structure, function, and/or feature of any of the optical calibration structures of any of paragraphs A1-A41.

D1. Non-transitory computer-readable storage media including computer-executable instructions that, when executed, direct an optical probe system to perform the method of any of paragraphs C1-C8.

### INDUSTRIAL APPLICABILITY

The optical calibration structures, optical probe systems, and methods disclosed herein are applicable to the optical device manufacturing and test industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

The invention claimed is:

1. An optical calibration structure for an optical probe of an optical probe system, the optical calibration structure comprising:
a reflector configured to receive an optical test beam of electromagnetic radiation from the optical probe and to reflect the optical test beam as a reflected beam and at a reflection angle with respect to the optical test beam; and
an optical detector configured to receive the reflected beam and to produce a detector electrical output that quantifies at least one property of the reflected beam;
wherein the electromagnetic radiation defines a beam path between the optical probe and the optical detector; and
wherein the optical calibration structure further includes an obstructive structure positioned along the beam path, wherein the obstructive structure includes an unobstructed region configured to permit electromagnetic radiation that is incident thereon to be received by the optical detector and an opaque region configured to restrict electromagnetic radiation that is incident thereon from being received by the optical detector.

2. The optical calibration structure of claim 1, wherein the optical calibration structure includes a plurality of reflectors, wherein each reflector of the plurality of reflectors is configured to receive a corresponding optical test beam of corresponding electromagnetic radiation from a corresponding optical probe along a corresponding beam path and to reflect the corresponding optical test beam as a corresponding reflected beam and at a corresponding reflection angle along the corresponding beam path, wherein the optical calibration structure further includes a plurality of obstructive structures, and further wherein each obstructive structure of the plurality of obstructive structures is positioned along the corresponding beam path and is configured to permit electromagnetic radiation that travels along the corresponding beam path and is incident upon a corresponding unobstructed region to be received by the optical detector and to restrict electromagnetic radiation that is incident upon a corresponding opaque region from being received by the optical detector.

3. The optical calibration structure of claim 2, wherein the plurality of reflectors is positioned such that the corresponding reflected beam of each reflector is incident upon the optical detector.

4. The optical calibration structure of claim 2, wherein the plurality of reflectors is configured such that the corresponding reflected beam reflected by each reflector extends at least substantially parallel to the corresponding reflected beam reflected by each other reflector of the plurality of reflectors.

5. The optical calibration structure of claim 2, wherein the plurality of reflectors is positioned such that the corresponding beam path of the corresponding electromagnetic radiation for each reflector extends from the corresponding optical probe to the optical detector.

6. The optical calibration structure of claim 2, wherein two reflectors of the plurality of reflectors face away from one another.

7. The optical calibration structure of claim 2, wherein at least one reflector of the plurality of reflectors is oriented at least substantially perpendicular with respect to at least one other reflector of the plurality of reflectors.

8. The optical calibration structure of claim 2, wherein the plurality of reflectors includes exactly three reflectors.

9. The optical calibration structure of claim 1, wherein the unobstructed region is at least substantially transparent to the electromagnetic radiation, wherein the opaque region is at least substantially opaque to the electromagnetic radiation, and further wherein the opaque region bounds the unobstructed region and extends around a transverse cross-section of the beam path.

10. The optical calibration structure of claim 1, wherein the obstructive structure is at least one of:
(i) positioned between the reflector and the optical detector; and
(ii) positioned between the optical probe and the reflector.

11. The optical calibration structure of claim 1, wherein the obstructive structure is positioned along the beam path of the optical test beam.

12. The optical calibration structure of claim 1, wherein the obstructive structure is at least one of:
(i) positioned at the reflector;
(ii) positioned on a face of a prism that defines the reflector; and
(ii) positioned within the prism.

13. The optical calibration structure of claim 1, wherein the unobstructed region includes an unobstructed opening configured to permit the electromagnetic radiation to pass therethrough.

14. The optical calibration structure of claim 1, wherein the unobstructed region includes at least one of an unobstructed pinhole structure and an unobstructed slit structure.

15. The optical calibration structure of claim 1, wherein the obstructive structure includes a plurality of spaced apart unobstructed regions, wherein the optical probe system includes an optical probe assembly that includes a plurality of optical probes, wherein the plurality of optical probes defines a probe pitch, wherein the plurality of spaced apart unobstructed regions defines an unobstructed region pitch, and further wherein at least one of:
(i) the unobstructed region pitch is at least substantially equal to the probe pitch; and
(ii) the unobstructed region pitch is an integer multiple of the probe pitch.

16. The optical calibration structure of claim 1, wherein the optical calibration structure further includes a sheet of transparent material, which is at least substantially transparent to the electromagnetic radiation, and further wherein the reflector is at least one of operatively attached to the sheet of transparent material and at least partially defined by the sheet of transparent material.

17. The optical calibration structure of claim 16, wherein the sheet of transparent material extends between the reflector and the optical detector.

18. The optical calibration structure of claim 16, wherein the obstructive structure is at least one of operatively attached to the sheet of transparent material, at least partially defined by the sheet of transparent material, defined on a surface of the sheet of transparent material, and defined within the sheet of transparent material.

19. An optical probe system, comprising:
the optical calibration structure of claim 1;
a chuck that defines a support surface configured to support a substrate that includes a plurality of optical devices;
an optical probe assembly including the optical probe; and
a signal generation and analysis assembly configured to at least one of provide the optical test beam to the optical probe and receive an optical resultant beam from the optical probe;
wherein the optical calibration structure is positioned to receive the optical test beam from the optical probe.

20. A method of calibrating a plurality of optical probes of an optical probe assembly of an optical probe system, wherein the optical probe system includes an optical calibration structure that includes a reflector, an optical detector, and an obstructive structure, the method comprising:
simultaneously providing a corresponding optical test beam of electromagnetic radiation to each optical probe of the plurality of optical probes;
responsive to the simultaneously providing, simultaneously emitting the corresponding optical test beam from each optical probe;
directing the corresponding optical test beam of a selected optical probe of the plurality of optical probes along a corresponding beam path that extends through the obstructive structure, is reflected by the reflector, and is incident upon the optical detector;
concurrently with the directing and utilizing the obstructive structure, restricting at least one other corresponding optical test beam of at least one other optical probe of the plurality of optical probes from being incident upon the optical detector; and
quantifying at least one property of the corresponding optical test beam of the selected optical probe utilizing the optical detector.
